(19) United States
(12) Patent Application Publication
(10) Pub. No.: US 2014/0243034 A1
(43) Pub. Date: Aug. 28, 2014

(54) METHOD AND APPARATUS FOR CREATING A TALKGROUP

(71) Applicant: MOTOROLA SOLUTIONS, INC., Schaumburg, IL (US)

(72) Inventors: DAVID P. GURNEY, CARPENTERSVILLE, IL (US); KAREN MARIE BARTUCH, CHICAGO, IL (US); HENRY F. CHIN, ROSELLE, IL (US); KENNETH W. DOUROS, SOUTH BARRINGTON, IL (US)

(73) Assignee: MOTOROLA SOLUTIONS, INC., Schaumburg, IL (US)

(21) Appl. No.: 13/773,992

(22) Filed: Feb. 22, 2013

(51) Int. Cl. H04W 4/08

(52) U.S. Cl. CPC H04W 4/08
USPC 455/519

(57) ABSTRACT

A method and apparatus for talkgroup creation are provided herein. During operation context-aware circuitry will continuously monitor a given area for a specific event or condition. When triggered, the context-aware circuitry will notify a radio controller of the trigger causing talkgroups to be formed specific to the event or condition that is detected. Thus, various radios will be included within a talkgroup as a direct result of the triggering event or condition.

### FIELD OF THE INVENTION

The present invention generally relates to communication systems, and more particularly to a method and apparatus for creating a talkgroup within such communication systems.

### BACKGROUND OF THE INVENTION

Modern two-way radio systems feature talkgroup creation where it is possible for a radio to be a member of any combination of talkgroups. As a member of a talkgroup, a radio may receive transmissions from, as well as transmit to all members of the talkgroup. Transmission and reception of information to radios outside of an assigned talkgroup is generally not performed. Illustratively, a radio assigned to an ambulance may be a member of a Fire & Rescue talkgroup as well as a Law Enforcement talkgroup. Therefore, the radio may communicate with all members of the Fire & Rescue talkgroup as well as the Law Enforcement talkgroup.

Various public safety situations (e.g., suspect building entry, hostage rescue, fire search and rescue, etc.) demand dynamic talkgroup creation. The creation may be both time and location specific for maximum benefit. For example, if a fire breaks out in a building, a talkgroup may be desired that includes the local fire department and the building operations personnel.

As is evident, techniques for dynamically assigning a radio to a talkgroup in a real-time fashion are desired.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram illustrating a general operational environment, according to one embodiment of the present invention.

FIG. 2 is a block diagram of a talkgroup assignment tag of FIG. 1.

FIG. 3 is a flow chart showing operation of the talkgroup assignment tag of FIG. 1 in accordance with a first embodiment.

FIG. 4 is a flow chart showing operation of the talkgroup assignment tag of FIG. 1 in accordance with a second embodiment.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to dynamically assign a radio to a talkgroup in a real-time fashion, a method and apparatus for talkgroup creation are provided herein. During operation context-aware circuitry will continuously monitor a given area for a specific event or condition. When triggered, the context-aware circuitry will notify a radio controller of the trigger causing talkgroups to be formed specific to the event or condition that is detected. Thus, various radios will be included within a talkgroup as a direct result of the triggering event or condition.

The above-described technique will allow for dynamic creation of talkgroups that are specifically tailored to a detected event or condition. For example, when context-aware circuitry comprises a smoke detector, upon triggering, a talkgroup may be created comprising building maintenance radios and the radios belonging to the local fire department. In another example, the proximity of users to a particular tagging device may be utilized to automatically form talkgroups.

For purposes of this disclosure and appended claims, as described herein, the term “radio” is defined as a device that either sources a media transmission (such as voice, data, etc.) in a two-way system, (i.e., a source device) or a device that is the target end recipient of the media transmission in the two-way system (i.e., the destination device). A controller is defined as a facilitating device communication within the infrastructure of the two-way system, which facilitates the creation of talkgroups.

The radios are also commonly referred to in the art as communication devices, subscribers, portables, user equipment (UE), access devices, access terminals, mobile stations, mobile subscriber units, mobile devices, user devices, and the like. The radios can be any type of communication device such as mobile phones, mobile data terminals, Personal Digital Assistants (PDAs), laptops, two-way radios, cell phones, etc. The controller can be, for instance, any suitable network device within the infrastructure of the two-way network.

As described herein, a communication group in a two-way system that communicates voice as media over a traffic channel is referred to as a “talkgroup” or “group”. A two-way system features a plurality of talkgroups where it is possible for a radio to be a member of any combination of talkgroups. Illustratively, an endpoint assigned to an ambulance may be a member of a Fire & Rescue talkgroup as well as a Law Enforcement talkgroup. Each radio engages in a communication session with a talkgroup by way of any combination of hardware and software and/or firmware.

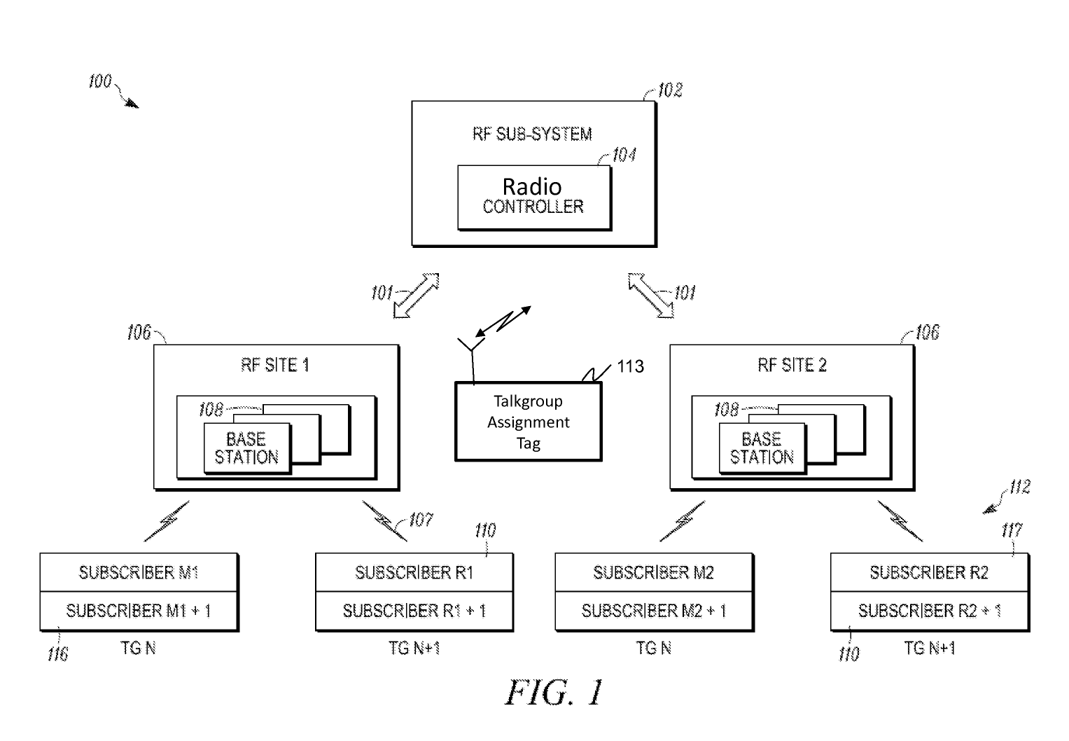

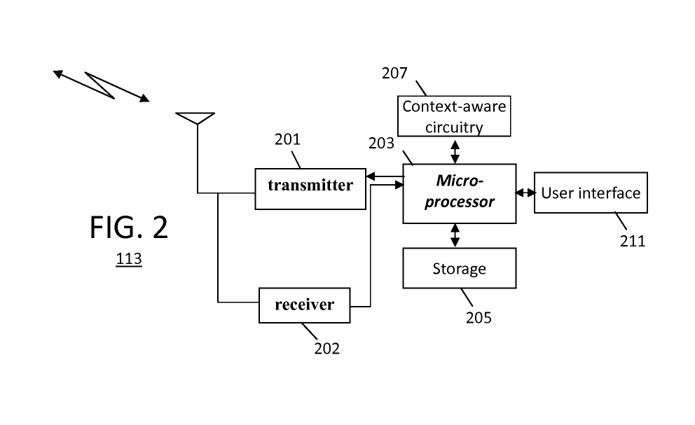

Turning now to the drawings wherein like numerals designate like components, FIG. 1 illustrates a two-way radio system 100. The two-way radio system 100 provides a general depiction of a physical implementation of various embodiments of the present disclosure. Specifically, the illustrative two-way radio system 100 is designed for implementation of various methods of establishing dynamic talkgroup creation, for example, by reference to FIGS. 2-6.

The two-way radio system 100 includes a plurality of radios (referred to herein as subscriber units) (e.g., M1, M1+1, M2, and M2+1 (of a talkgroup (TG) N) and R1, R1+1, R2, and R2+1 (of a talkgroup N+1)), which communicate with each other using one or more base stations 108 located at radio frequency (RF) sites 1 and 2 (106). A Radio Frequency Sub-system (hereinafter “RFSS”) 102 and the subscribers perform methods for establishing point-to-point communications in the two-way radio system 100, in accordance with the teachings herein.

As shown in FIG. 1, the RFSS 102 is in communication with the plurality of radio frequency site systems 106 as indicated, for instance, by arrow 101. The interface between the radio frequency site systems 106 and the RFSS 102 may be either wired or wireless. The RFSS 102 may include a radio controller 104, which is described further below.

Each radio frequency site system 106 may include a number of infrastructure devices including, among others, a control station (not shown), a plurality of base stations 108, and corresponding relay (not shown) that collectively provide communication services to a plurality of subscribing talk groups 112 (e.g., TG N and TG N+1) within a predetermined geographical coverage region for the RF site 106. At each radio frequency site system 106, each base station from the plurality of base stations 108 wirelessly communicates with the RFSS 102. Moreover, in one illustrative implementation, each base station 108 is configured or adapted to wirelessly communicate (e.g., as indicated by links 107) with one or more subscribers or “endpoints” from a plurality of subscribers 110 within the plurality of talkgroups 112. Alternatively, the interface between the base stations and the subscribers can be wired. Illustratively shown in FIG. 1, in terms of public safety, a base station 108 is assigned to talk group N, among others, such that the base station 108 wirelessly communicates with Subscriber M1 at Radio Frequency Site 106 RF Site No. 1 as well as Subscriber M2 at Radio Frequency Site 106 RF Site No. 2.

Devices in the two-way network 100, may include the RFSS 102 elements, the radio frequency sites 106, the subscribers and other well known infrastructure devices (not shown) in the two-way network 100, generally include a memory, one or more network interfaces, and a processing device or processor (although not shown) that are operatively coupled, and which when programmed form the means for the device to implement its functionality, for example, as illustrated by reference to the methods and diagrams shown in FIGS. 2-6.

The network interfaces are used for passing signaling, also referred to herein as messaging, (e.g., messages, packets, datagrams, frames, superframes, or any other information blocks) between the elements of the system 100. The implementation of the network interfaces in a given device depends on the particular type of network, i.e., wired and/or wireless, to which the device is connected. For example, where the network supports wired communications, the interfaces may comprise a serial port interface, a parallel port interface, an Ethernet interface, a USB interface, and/or a FireWire interface, and other well known interfaces.

Where the network supports wireless communications, the interfaces comprise elements including processing, modulating, and transceiver elements that are operable in accordance with any one or more standard or proprietary wireless over-the-air interfaces, wherein some of the functionality of the processing, modulating, and transceiver elements may be performed by means of the processing device through programmed logic such as software applications or firmware stored on the memory device of the system element or through hardware.

In addition to the above-mentioned functionality, implemented via programmed logic or code, the processor of a given device may be further programmed with software or firmware logic or code for performing signaling and functionality to facilitate methods in accordance with the teachings disclosed herein, such as, among others, methods described by reference to FIGS. 2-6. Furthermore, the processing device may be implemented on hardware, for example, as a state machine or an application specific integrated circuit, “ASIC” to perform such functionality. The memory in a device includes any readily recognizable combination of short-term and long-term storage of software or firmware for programming the processing device with the logic or code needed to perform its functionality and for storage of various data needed for the functioning of the device and its intended functionality.

Turning now to a description of the various elements shown in FIG. 1, as mentioned above, the plurality of talkgroups 112 includes a talkgroup N and a talkgroup N+1. As illustratively shown, the talkgroup N includes the subscriber M1 and the subscriber M1+1 each communicatively coupled to the radio frequency site system 106 RF Site 1 as well as the subscriber M2 and the subscriber M2+1 communicatively coupled to the radio frequency site system 106 RF Site 2. Similarly, the talkgroup N+1 includes the subscriber R1 and the subscriber R1+1 each communicatively coupled to the radio frequency site system 106 RF Site 1 as well as the subscriber R2 and the subscriber R2+1 communicatively coupled to the radio frequency site system 106 RF Site 2. In some embodiments, each of the plurality of talkgroups 112 is preconfigured with specified subscribers or may be dynamically assigned as discussed below in response to talkgroup assignment tag 113 detecting a specific event. In one example, one or more devices used by a medical rescue participant are elected, ad hoc, as part of both a law enforcement talkgroup as well as a fire talkgroup in response to an emergency situation detected by talkgroup assignment tag 113.

In a conventional or “non-trunked” system, users control access of their subscribers to traffic or voice channels by directly selecting a frequency, channel, or talkgroup. Talkgroups may still be established and assigned in these systems (e.g., statically via initial radio programming or dynamically via over-the-air (OTA) programming). Subscribers may be assigned to those talkgroups via over-the-air communications methods (e.g., OTA programming or other signaling). However, inherent to the two-way network 100, the radio controller 104 manages system operation, including talkgroup creation and management. In particular, the radio controller 104 may signal the subscribers 110 by way of an outbound signaling packet (hereinafter “OSP”). Such system operation in the two-way network 100 includes, for example, granting subscriber access to traffic channels and signaling subscribers over a control channel as to their currently assigned talkgroups.

A control channel, as used herein, is defined as a channel used by the controller to coordinate communications for the subscribers within the talkgroups, for example, through traffic channel assignments for all or some of the subscribers in the talkgroups. In some embodiments, the control channel comprises a dedicated or “primary” control channel. Alternatively, the control channel may comprise a composite control channel, where the composite control channel can act as a traffic channel when no other traffic channels are available often due to congestion. The control channel signaling may also be “in-band” (i.e., take place in-line with normal data transmissions) depending on the system type. In other embodiments, a secondary control channel is provided. The secondary control channel is used, for example, when the dedicated control channel is not available.

Upon powering up, each subscriber 110 may receive an assigned active control channel via an OSP periodically sent by the radio controller 104. Accordingly, each subscriber 110 may scan from a list of control channels to find the active control channel for the two-way system 100. The subscribers 110 may listen on the active control channel for a voice channel assignment that corresponds to a designated talkgroup from the plurality of talk groups 112. The radio controller 104 is able to distinguish each subscriber according to an authentication certificate and with a public key assigned to that particular subscriber. The OSP, as directed by the radio controller 104, periodically provides the voice channel and talkgroup assignment to the subscribers 110. In some embodiments, all of the plurality of talkgroups 112 are assigned to the same voice channel. Alternatively, each of the plurality of talkgroups 112 may be assigned to a different voice channel. Also, a subset of the plurality of talkgroups 112 can share a voice channel.

As discussed above, various public safety situations demand dynamic talkgroup creation. The creation may be both time and location specific. In order to address this need talkgroup assignment tag 113 is provided. During operation context-aware circuitry within tag 113 will continuously monitor a given area for a specific event or condition. When triggered by the event or condition, tag 113 will notify a radio controller 104 of the trigger causing talkgroups to be formed specific to the event or condition that is detected. In a first embodiment tag 113 will access an internal database to determine those radios that should be included in a newly-created talkgroup. In a second embodiment, tag 113 will simply provided controller 104 of an event (e.g., smoke detected at 113 Main Street, floor 2). In response to the provided event, controller 104 will access an internal database to determine those radios that should be joined to create a talkgroup.

FIG. 2 is a block diagram of talkgroup assignment tag 113. Tag 113 typically comprises processor 203 that is communicatively coupled with various system components, including transmitter 201, receiver 202, general storage component 205, context-aware circuitry 207, and potentially, a user interface (GUI) 211. Only a limited number of system elements are shown for ease of illustration; but additional such elements may be included in the tag 113.

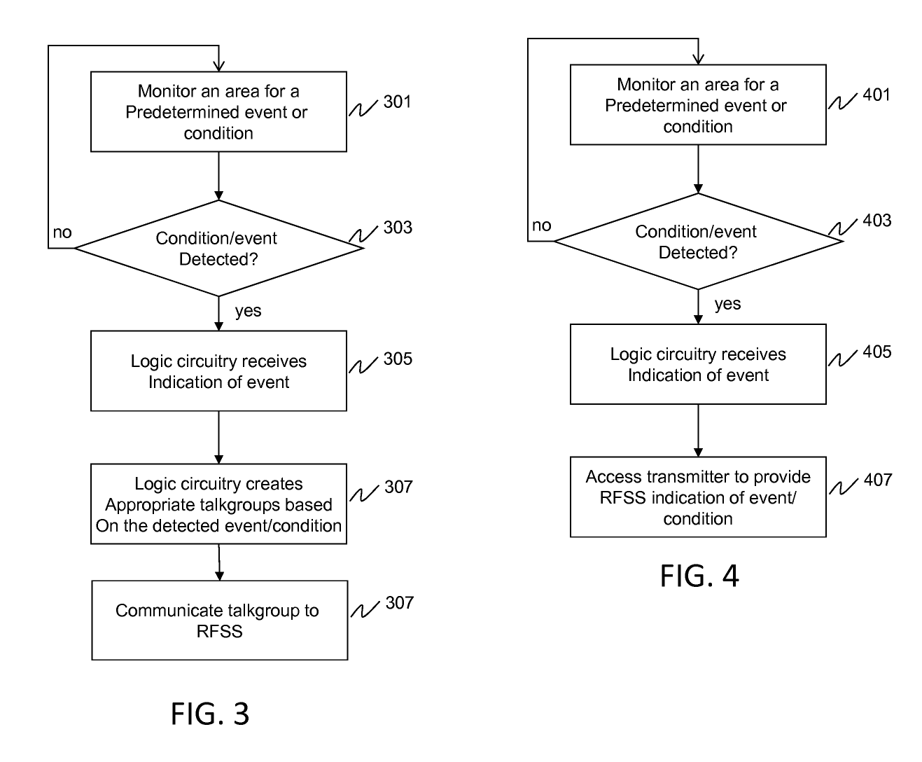

Processing device 203 may be partially implemented in hardware and, thereby, programmed with software or firmware logic or code for performing functionality described in FIG. 3; and/or the processing device 203 may be completely implemented in hardware, for example, as a state machine or ASIC (application specific integrated circuit). Storage 205 can include short-term and/or long-term storage of various information needed for the recall of specific talkgroups to be created upon the triggering of an event or condition. Storage 205 may further store software or firmware for programming the processing device 203 with the logic or code needed to perform its functionality.

User interface 211receives an input from a user that may be used in talkgroup creation. In addition, in an embodiment, User interface 211 provides a way of conveying (e.g., via video or audio means) information to the user. In particular, in an embodiment, event information may be displayed to the user along with talkgroups created. In order to provide the above features (and additional features), User interface 211 may include a keypad, a display/monitor, a mouse/pointing means, and/or various other hardware components to provide a man/machine interface.

In a first embodiment, context-aware circuitry 207 preferably comprises a smoke or fire detector, however in alternate embodiments circuitry 207 may comprise any device capable of generating information used to create a talkgroup. For example, context-aware circuitry 105 may comprise a short-range receiver (e.g., Bluetooth receiver), that creates talkgroups based on the presence of one or more detected devices. For example, radios within a pre-defined proximity to the tag 113 (as detected via a Bluetooth receiver) will be assigned to a particular talkgroup. Regardless of the makeup of context-aware circuitry 207, logic circuitry 203 will use information generated by circuitry 207 to determine form the appropriate talkgroups.

Transmitter 201 and receiver 202 are common circuitry known in the art for communication utilizing a well known communication protocol, and serve as means for transmitting and receiving messages. For example, receiver 302 and transmitter 301 may be well known long-range transceivers that utilize the Apco 25 (Project 25) communication system protocol. Other possible transmitters and receivers include, IEEE 802.11 communication system protocol, transceivers utilizing Bluetooth, HyperLAN protocols, or any other communication system protocol. Talkgroup assignment tag 113 may contain multiple transmitters and receivers, to support multiple communications protocols. Short-range communications means such as Bluetooth or 802.11 may additionally be utilized to detect other radio users (subscribers) within a pre-determined proximity of the tag 113 (see also below).

In a preferred embodiment processor 203 receives a notification from context-aware circuitry 207 that an event or condition has occurred. A wireless transmission to radio controller 104 may take place over a common control channel. In a first embodiment this transmission comprises specific talkgroup assignment that is to be made by controller 104. In a second embodiment this transmission comprises an indication of the event. In response to this indication, controller 104 will create specific talkgroups. In yet another embodiment, the tagging device 113 may communicate directly with the subscriber units to dynamically program talkgroups.

As discussed above, context-aware circuitry 207 may comprise any number of system elements but preferably comprises an environmental sensor. Some possible environmental sensors are described below:

Smoke Detector—Circuitry 207 may comprise a smoke detector. When smoke is detected a talkgroup may be created that includes desired radios. For example, when smoke is detected, police, fire, and building maintenance may be included in a single talkgroup.

Fire Detector—Circuitry 207 may comprise a fire detector such as a temperature sensor, an oxygen sensor, or smoke detector. When fire is detected (via a high temperature, low oxygen, or smoke being detected) a talkgroup may be created that includes desired radios. For example, when a fire is detected, police, fire, and building maintenance may be included in a single talkgroup.

Short-range receiver—Circuitry 207 may comprise a short-range receiver, for example, a Bluetooth or 802.11 receiver. When a particular radio device or subscriber is detected via the short-range receiver (e.g., based on signal received signal strength levels or explicit location information), a talkgroup may be created that includes the desired radio devices. For example, tagging device(s) 113 may be placed at particular location(s) in a building (e.g., at room entry points, etc.) during a fire or police operation. Any public safety officer (radio subscriber) that comes within a pre-defined proximity of the tagging device 113 may be automatically added to a talkgroup that provides information relevant to that particular location. This information may be stored on the tagging device itself. The triggering event, in this case, is that a new subscriber is detected within proximity of the tagging device. Subscribers assigned to a particular talkgroup may be automatically removed from that talkgroup if they leave the proximity of the tagging device, or alternately, they may be removed after a pre-determined period of time. Also note that the tagging device may be mobile (e.g., placed on a person of interest, such as for a security detail, in which officers within a certain proximity of a tagged person will automatically be added to the security detail talkgroup).

Water Detector—Circuitry 207 may comprise a water or fluid detector. When water or other fluids detected a talkgroup may be created that includes desired radios. For example, when a flooded basement is detected, public works and building maintenance may be included in a single talkgroup.

Motion Detector—Circuitry 207 may comprise a detector used for motion detection. Such a sensor may include, but is not limited to an audio detector, a video camera, etc. that detects motion. In this manner, a talkgroup may be created based on motion detected in an area. For example, a bank vault may comprise a motion detector, that during off hours, creates a specific talkgroup when motion is detected.

FIG. 3 is a flow chart showing operation of talkgroup assignment tag 113 in accordance with a first embodiment. In the first embodiment TAG 113 determines the radios that belong to specific talkgroups when an event or condition occurs. TAG 113 communicates this information to RFSS 102 for the creation of the talkgroup.

The logic flow begins at step 301 where context-aware circuitry 207 continuously monitors an area for a predetermined event or condition. As discussed above, context-aware circuitry may comprise an environmental sensor. At step 303, context-aware circuitry 207 determines if a predetermined event or condition has been detected. If, at step 303, it is determined that a predetermined event has not occurred, the logic flow returns to step 301. However, if at step 303 it has been determined that a predetermined event has occurred, the logic flow continues to step 305 where microprocessor 203 is provided an indication that the event has occurred. In response, microprocessor 203 determines/creates an appropriate talkgroup to create (step 307) based on the event or condition detected. Step 307 may entail accessing storage 205 (an internal database) that conations the talkgroup to be created when the event has been detected. The internal database is accessed in order to retrieve a stored talkgroup that is created when a particular event has occurred. Alternatively, step 307 may simply entail the addition of a particular detected radio to the talkgroup. Alternatively, step 307 may entail the removal of a radio that is no longer detected.

Regardless of how microprocessor 203 determines a talkgroup that needs to be created, the logic flow continues to step 309 where the determined talkgroup is communicated/transmitted via an over-the-air control channel to transmitter 201 to RFSS 102 (and ultimately to radio controller 104) which creates and assigns appropriate radios/subscribers to the talkgroup.

FIG. 4 is a flow chart showing operation of talkgroup assignment tag 113 in accordance with a second embodiment. In this particular embodiment TAG 113 detects a particular event or condition and provides an indication of the detected event to RFSS 102. RFSS 102 then creates an appropriate talkgroup.

The logic flow begins at step 401 where context-aware circuitry 207 continuously monitors an area for a predetermined event or condition. At step 403, context-aware circuitry 207 determines if a predetermined event or condition has occurred. If, at step 403, it is determined that a predetermined event has not occurred, the logic flow returns to step 401. However, if at step 403 it has been determined that a predetermined event has occurred, the logic flow continues to step 405 where microprocessor 203 is provided an indication that the event has occurred. In response, microprocessor accesses transmitter 201 and instructs transmitter 201 to provide RFSS 102 with an indication or notification that the event or condition has occurred along with identification information for TAG 113 (step 307). The transmission is preferably accomplished via an over-the-air control channel transmission. In response, RFSS 102 utilizing radio controller 104 will create an appropriate talkgroup. This may entail RFSS 102 accessing internal storage (not shown in FIG. 1) in order to retrieve a stored talkgroup that is created when a particular event has occurred. Alternatively, RFSS 102 may add a particular detected radio to the talkgroup. Alternatively, RFSS 102 may removal of a radio that is no longer detected.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for creating a talkgroup, the method comprising the steps of:
detecting that an event or condition has occurred via an environmental sensor; and
creating a talkgroup based on the event or condition detected.

2. The method of claim 1 wherein the environmental sensor comprises a sensor taken from the group consisting of a fire detector, a temperature sensor, an oxygen sensor, a smoke detector, a short-range receiver, a water detector, and a motion detector.

3. The method of claim 1 wherein the step of creating the talkgroup comprises the steps of:
accessing an internal database that contains the talkgroup to be created when the event has been detected; and
transmitting the talkgroup to a radio controller.

4. The method of claim 3 wherein the step of transmitting comprises the step of transmitting via an over-the-air control channel.

5. The method of claim 1 wherein the step of creating the talkgroup comprises the steps of:
transmitting a notification that the event or condition exists to a radio controller, wherein the radio controller determines the talkgroup.

6. The method of claim 5 wherein the step of transmitting comprises the step of transmitting via an over-the-air control channel.

7. An apparatus for creating a talkgroup, the apparatus comprising:
context-aware circuitry detecting that an event or condition has occurred via an environmental sensor; and
logic circuitry creating a talkgroup based on the event or condition detected.

8. The apparatus of claim 7 wherein the environmental sensor comprises a sensor taken from the group consisting of a fire detector, a temperature sensor, an oxygen sensor, a smoke detector, a short-range receiver, a water detector, and a motion detector.

9. The apparatus of claim 7 further comprising:
storage that contains the talkgroup to be created when the event has been detected; and
a transmitter transmitting the talkgroup to a radio controller.

10. The apparatus of claim 9 wherein the step of transmitting comprises the step of transmitting via an over-the-air control channel.

11. The apparatus of claim 7 further comprising:
a transmitter; and
wherein the logic circuitry creates the talkgroup by instructing the transmitter to transmit a notification that the event or condition to a radio controller, wherein the radio controller determines the talkgroup based on the event or condition.

12. The apparatus of claim 5 wherein the transmitting occurs via an over-the-air control channel.
